(19) United States
(12) Patent Application Publication
(10) Pub. No.: US 2004/0256874 A1
(43) Pub. Date: Dec. 23, 2004

(54) Recreational vehicle with side out members

(76) Inventor: William J. Rex, Canyon Country, CA (US)

Correspondence Address: STETINA BRUNDA GARRED & BRUCKER, 75 ENTERPRISE, SUITE 250, ALISO VIEJO, CA, 92656, US

(21) Appl. No.: 10/821,314

(22) Filed: Apr. 9, 2004

Related U.S. Application Data
(60) Provisional application No. 60/462,132, filed on Apr. 11, 2003.

(51) Int. Cl. B60P 3/34

(52) U.S. Cl. 296/26.13

(57) ABSTRACT

A recreational vehicle comprising a chassis having a cab and a back wall attached thereto. An opposed pair of side walls are at least partially defined by a portion of the cab. Moveably attached to the chassis is a pair of slide outs which each extend from the cab to the back wall. Each of the slide outs defines an outer wall, and is selectively moveable between an extended position and a retracted position. When the slide outs are in the retracted position, the outer walls thereof are substantially flush with respective ones of the first and second side walls. When the slide outs are in the extended position, the outer walls thereof protrude outwardly from respective ones of the first and second side walls.

### CROSS-REFERENCE TO RELATED APPLICATIONS

This application claims priority to U.S. Provisional Application Ser. No. 60/462,132 entitled RECREATIONAL VEHICLE filed Apr. 11, 2003.

### STATEMENT RE: FEDERALLY SPONSORED RESEARCH/DEVELOPMENT

Not Applicable

### BACKGROUND OF THE INVENTION

The present invention relates generally to a recreational vehicle (RV) and, more particularly, to an RV comprising at least one slide-out member spanning nearly the entire length of the RV so as to dramatically increase the usable interior living space of the RV.

RVs have become increasingly popular among people who travel for extended periods of time, particularly among people who drive to a particular destination such as a national or state park and reside there for extended periods. A typical RV comprises a plurality of wheels, a chassis built atop the wheels, and a plurality of walls built atop the chassis, with a floor and a roof connected thereto. The walls, floor and roof collectively define an enclosed living space. Generally, the living space is equipped with amenities such as a refrigerator, stove, oven, sink, toilet, shower, and furniture. Additionally, an RV either comprises a motor and cab section operative to make the same independently mobile (in the case of a motor home) or is configured so as to be towable by a separate vehicle (in the case of a fifth-wheel or tag-along travel trailer).

Many RV users desire RVs equipped with certain amenities and providing room to freely move about. RV manufacturers have created space-saving interiors in an attempt to maximize both the amenities contained therein and the room to move about available to the RV user. Nonetheless, many RV users consider such interiors to be cramped and uncomfortable. However, as federal and state law limits the maximum length and width of mobile vehicles, the interior living space available in conventional RVs is necessarily limited. In order to address customer demand and yet meet the legal size requirements, RV manufacturers have developed RVs with extendable structures, often referred to as “slide-outs.” Such RVs typically comprise a body having a wall defining an opening sized according to the length of the slide-out. The slide-out itself typically comprises a plurality of walls, an open side, a floor, and a roof collectively defining an interior space. The slide-out is positioned within the opening of the RV wall such that the open side of the slide-out faces into the interior of the RV body, thus creating a continuous interior living area.

The slide-out is movable between a retracted position and an extended position. In the retracted position, the slide-out lies within the RV body, the side wall of the slide-out lying flush with the side wall of the RV such that width of the RV conforms to federal and state vehicle size requirements. In the extended position, the slide-out is offset horizontally from the side of the RV such that both the floor of the RV body and the floor of the slide-out become available for use, thus increasing the interior living space.

Various embodiments of slide-outs have been disclosed in, for example, U.S. Pat. Nos. 6,048,016, 6,286,883, and 6,202,362. These conventional slide-outs span only a portion of the side of the respective RV. Thus, the available living space of these RVs is not significantly increased.

RV manufacturers have limited the length of conventional slide-outs for a variety of reasons. One of these reasons is the additional weight associated with an increase in the length of a slide-out. The weight of a longer slide-out may exceed the maximum weight supportable by the support system by which the slide-out is connected to a conventional RV when the slide-out is in the extended position, causing the slide-out to sag relative to the body of the RV. Ultimately, sagging may cause misalignment between the slide-out and the RV body, thus making the extension and/or retraction of the slide-out problematic and potentially damaging the actuating systems. Furthermore, misalignment can open paths for moisture and/or debris to enter the interior living space.

Slide-out length is additionally limited because of weight limitations of the mechanism by which the slide-out is moved. Typically, the floor of a conventional slide-out lies above the floor of the RV body when the slide-out is in the retracted position. The slide-out is moved both horizontally and vertically such that, when the slide-out is in its fully extended position, the slide-out floor is flush with the floor of the RV body. An example of this type of horizontally and vertically moving slide-out is disclosed in U.S. Pat. No. 6,293,611, filed Aug. 28, 2000 by Schneider et al. As the length of the slide-out is increased, the weight of the slide-out proportionally increases. Vertical movement of the heavier slide-out and, thus, the achievement of a flush fit between the floors of the slide-out and of the RV body become less feasible.

Yet another reason manufacturers have limited the length of conventional slide-outs is the difficulty of achieving adequate structural integrity in an RV having a large slide-out. In this regard, it should be noted that RVs are subject to load from a wide variety of sources (e.g., vibrational and inertial loading due to driving and weight loads from the various components of the RV and the appliances, holding tanks, propane tanks, furniture, and occupants thereof). Nonetheless, RV users typically expect an RV to be long-lasting and durable, and to provide some degree of protection to the occupants of the RV in the event of a vehicular collision. However, in order to accommodate a slide-out, an opening is formed along the side of the RV body. As the size of the slide-out is increased, the size of the opening in the RV body must be increased as well. A larger opening may compromise the structural integrity of the RV and decrease the durability thereof.

Finally, slide-out size has been limited due to logistical difficulties of mounting various amenities (e.g., appliances, plumbing fixtures, furniture and the like) within the RV. As the size of the slide-out increases, fixed areas in the RV decrease, thus increasing a need for various amenities to be mounted to the slide-out. This can be problematic, particularly for plumbing fixtures and for appliances operated by propane. In this regard, sinks, toilets, showers, and the like typically require plumbing to provide an inflow of water and outflow of waste water, while stoves and heaters often require piping to link an associated heating element to a propane tank. If these items are mounted on a moveable slide-out, extendable pipes are typically required to maintain the same in fluid connection with, for example, a holding tank or propane tank. However, extendable pipes are generally undesirable because the integrity thereof may be compromised by repeated movement. Furthermore, when an amenity is positioned on the slide-out, special attention must be paid in order to ensure that the amenity cannot interfere with any other amenity or RV component when the slide-out is moved. Thus, RV manufacturers typically limit the size of slide-outs so that critical appliances, plumbing fixtures, furniture and the like can be mounted in a fixed position away from the slide-out.

Thus, it will be appreciated that there is a significant need for an RV with one or more extended-length slide-outs. Additionally, the extended-length slide-out would not sag relative to the RV body, and the RV body would have adequate structural integrity. Furthermore, the floor of the full-length slide-out would lie flush with the floor of the RV body. Also, the RV would incorporate amenities that are positioned so as to minimize the need for extendable piping.

### BRIEF SUMMARY OF THE INVENTION

In accordance with the present invention, there is provided a recreational vehicle (RV) comprising a chassis having a plurality of wheels mounted thereto, the wheels being operative to provide movement to the RV in conjunction with a motor, transmission, etc., along with a cab section having various components (e.g., a steering wheel, accelerator pedal, brake pedal, etc.) operative to enable an operator to controllably move the RV. Alternatively, the RV may be configured so as to be towable by a separate vehicle via a fifth-wheel hitch or a tag-along hitch. Also mounted to the chassis are a retractable floor, a plurality of walls (i.e., a front wall, back wall, driver's side wall and curb-side wall) and a roof collectively defining an interior space comprising at least an interior living space. Each of the side walls further comprises an opening. The interior space may additionally comprise a cab section at the front thereof. The RV further comprises an extended-length slide-out slidably mounted to the driver's side wall and the curb side wall and extending the majority of the length of the RV from the rear of the cab section to the rear wall of the RV. Each slide-out comprises a floor, a plurality of walls (i.e., a front wall, a side wall and a back wall), and a roof collectively defining an interior living space. Each slide-out further comprises an open side facing the interior of the RV body. Further, each slide-out is movable between a retracted and an extended position. In the extended position, each slide-out is operative to dramatically increase the usable interior living space of the RV. In the retracted position, each slide-out is contained within the RV body such that the width of the RV meets federal and state width requirements for mobile vehicles.

Further in accordance with the present invention, there is provided a method of manufacturing an RV having extended-length slide-outs. The method comprises the initial steps of modularly fabricating the RV body and each slide-out. Each slide-out is provided with various amenities such as appliances and/or plumbing fixtures. The method of manufacture further comprises the step of slidably mounting the first fully-assembled slide-out on one side of the chassis within the opening of the respective wall. Finally, the method of manufacturing comprises the step of slidably mounting the second fully-assembled slide-out on the second side of the chassis within the opening of the respective wall.

### BRIEF DESCRIPTION OF THE DRAWINGS

These, as well as other features of the present invention, will become more apparent upon reference to the drawings wherein:

FIG. 1 is a perspective view of a recreational vehicle (RV) constructed in accordance with the present invention, comprising two slide-outs shown in the extended position;

FIG. 2 is a perspective view of the RV of FIG. 1, with the two slide-outs thereof shown in the retracted position;

FIGS. 3A-3C are top, side and end views of an RV chassis having a pair of slide-outs mounted atop the chassis and illustrating one embodiment of a slide-out actuation system;

FIGS. 4A and 4B are end views of the RV showing the support system of the slide-out, wherein the slide-out is in a retracted and an extended position, respectively;

FIG. 5 is a detail view of the support system shown in FIGS. 4A and 4B;

FIGS. 6A-6D are top and end views of the RV wherein the pair of slide-outs are shown in the retracted and extended positions, and further showing an actuating sub-floor with a floor retention system;

FIGS. 7A and 7B are a top and end view of the RV showing support members thereof; and

FIG. 8 is a flow chart illustrating a method of manufacturing an RV with extended-length slide-outs.

Common reference numerals are used throughout the drawings and detailed description to indicate like elements.

### DETAILED DESCRIPTION OF THE INVENTION

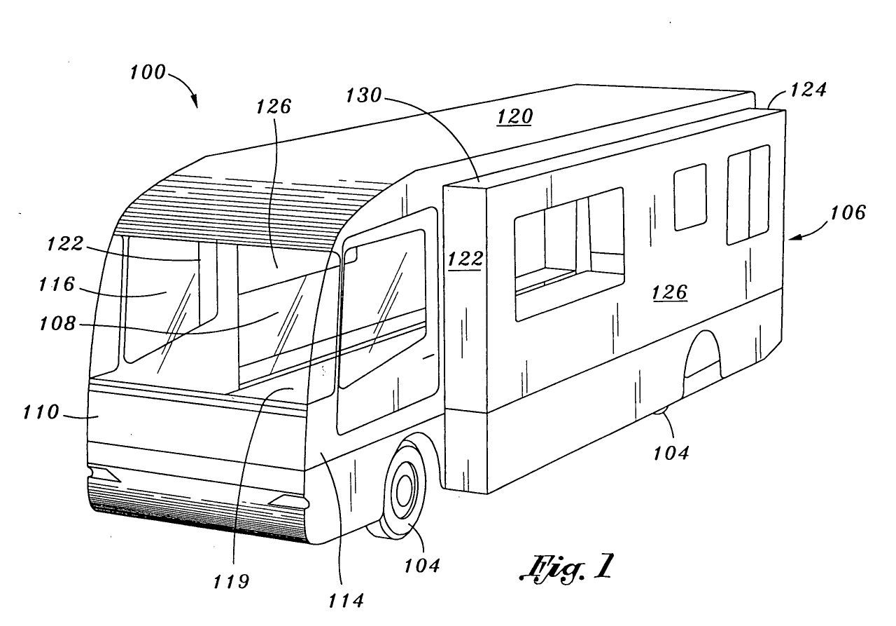

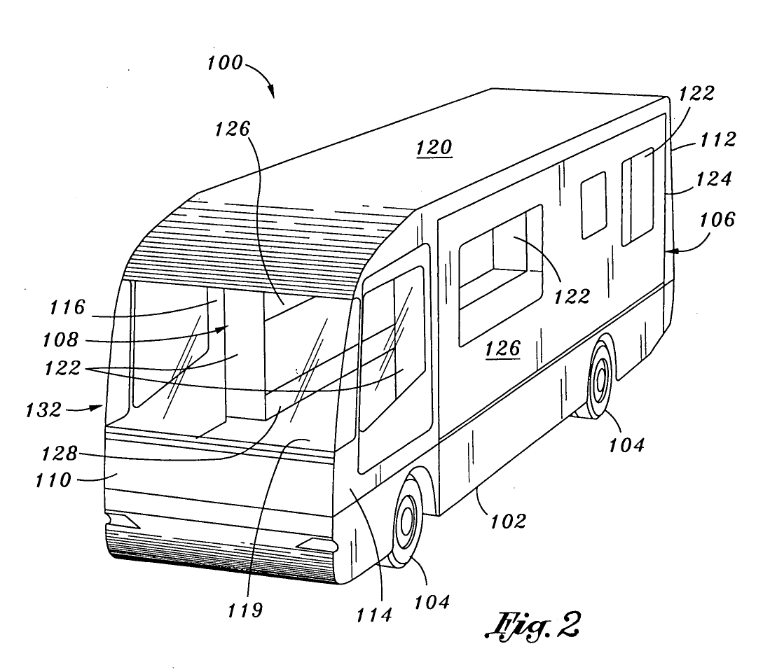

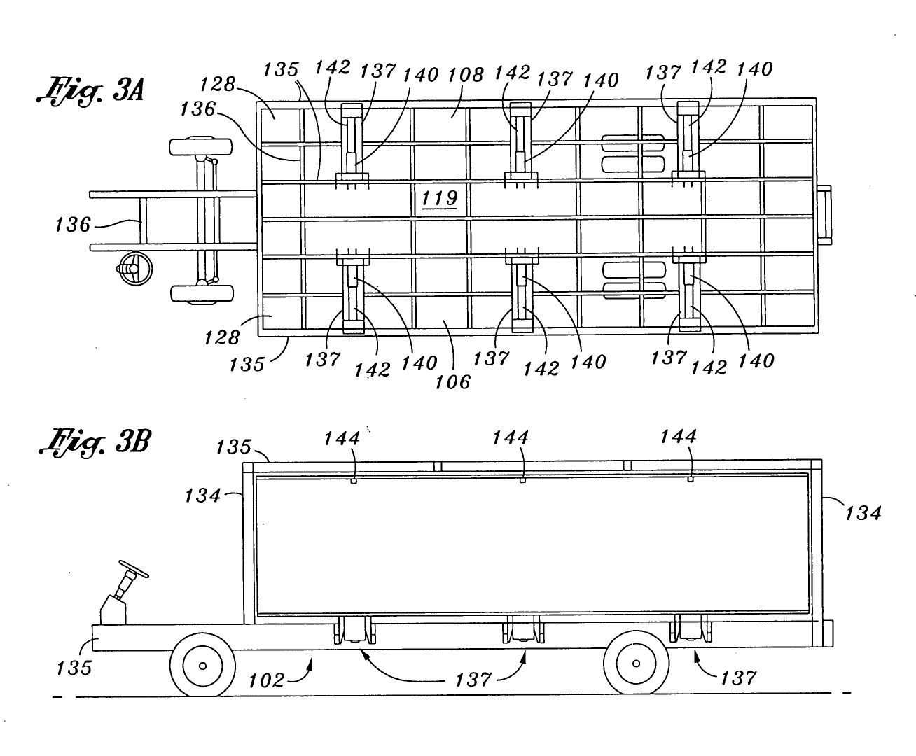

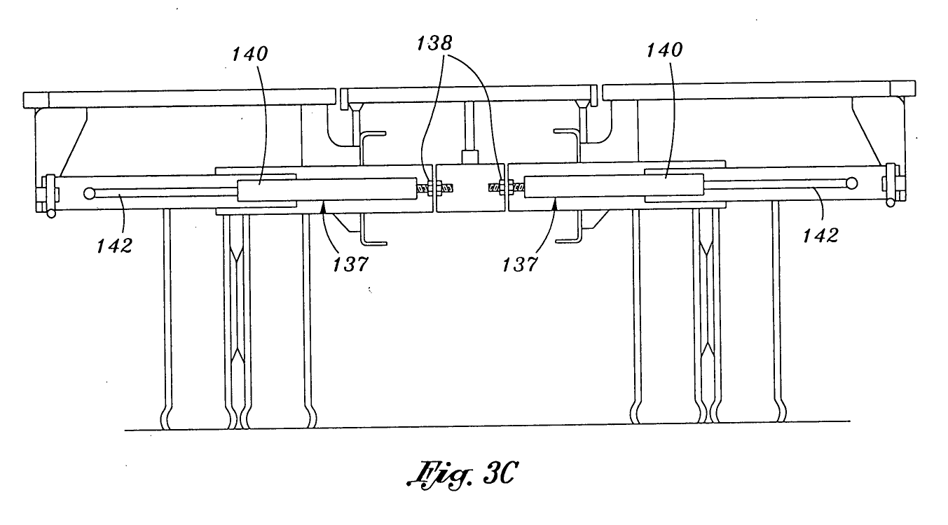

Referring now to the drawings wherein the showings are for purposes of illustrating preferred embodiments of the present invention only, and not for purposes of limiting the same, FIGS. 1 and 2 illustrate a recreational vehicle (RV) 100 having two extended-length slide-outs 106, 108, constructed in accordance with the present invention. The RV 100 comprises a chassis 102 which itself comprises a plurality of beams 134, longitudinal support bars 135, and lateral support bars 136 (shown in FIGS. 3A and 3B) interconnected to form an elongate frame. A front and back axle, each having at least two wheels 104 attached thereto, are mounted to the chassis 102, the wheels 104 being operative to provide rollable movement to the RV 100 in conjunction with a motor, transmission, etc. and also in conjunction with various components (e.g., a steering wheel, an accelerator pedal, brake pedal, etc.) operative to enable an operator to controllably move the RV 100. Alternatively, the RV 100 may be configured so as to be towable by a separate vehicle via a fifth-wheel hitch or a tag-along hitch. The RV 100 further comprises a retractable interior floor 118 (which will be described in more detail below) having a planar floor section 119. Additionally, the RV 100 comprises a front wall 110, a back wall 112, a driver's side wall 114, a curb-side wall 116, and a roof 120. Each of the side walls 114, 116 comprises an opening into which a slide-out is inserted. Preferably, the openings each extend almost from the back of the cab 132 to the back wall 112, and from the base of the chassis 102 to the roof 120. At least one of the walls 112, 114, and 116 further comprises a door (not shown). At least one window is mounted to at least the walls 110, 114, and 116.

Each slide-out 106, 108 itself comprises a frame (not shown), front wall 122, back wall 124, and side wall 126 which are substantially parallel to respective ones of the walls 110, 112, 114 and 116 of the RV 100. One or more of the walls 122, 124, and 126 may further comprise a window, while the side wall 126 may further comprise a door. Further, each slide-out 106, 108 comprises a floor 128 disposed in generally perpendicular or normal relation to the walls 122, 124, and 126. Each slide-out 106, 108 additionally comprises a roof 130 disposed in generally perpendicular or normal relation to the walls 122, 124, and 126. Each slide-out 106, 108 is slidably connected to the RV 100 in a manner which will be discussed in more detail below.

The walls 110, 112, 114, and 116, planar floor section 119 of the interior floor 118, and roof 120 of the RV 100 collectively define an interior space which defines at least an interior living space. The interior space may further comprise a cab 132 into which the steering wheel, accelerator pedal, brake pedal, and the like are positioned, with an engine compartment having a motor, transmission, etc. (not shown) disposed adjacent thereto. Likewise, the walls 122, 124, and 126, interior floor 128, and roof 130 of each slide-out 106, 108 collectively define a respective interior space. The interior space of the RV 100 and the interior space of each slide-out 106, 108 slidably attached to the RV 100 collectively define at least an interior living space.

As shown in FIGS. 1 and 2, the slide-outs 106, 108 are movable between an extended position (as shown in FIG. 1) and a retracted position (as shown in FIG. 2) in a manner which will be discussed in more detail below. In the retracted position, the front walls 122, back walls 124, floors 128, and roofs 130 of each slide-out 106, 108 are positioned within the body of the RV 100, with the floors 128 each being positioned over at least a portion of the interior floor 118 of the RV. The side wall 126 of each slide-out 106, 108 is substantially flush with a respective side wall 114, 116 of the RV 100. Thus, when the slide-outs 106, 108 are in the retracted position, the RV 100 meets federal and state width requirements for mobile vehicles and is therefore suitable for being driven.

When the slide-outs 106, 108 are in the extended position, each slide-out 106, 108 is offset horizontally from the chassis 102 of the RV 100 such that the side wall 126 of each slide-out 106, 108 is separated by a distance from a respective one of the side walls 114, 116 of the RV 100. The floor 128 of each slide-out 106, 108 is also offset horizontally, exposing the interior floor 118 and, thus, increasing available floor space. In one embodiment of the present invention, available floor space is increased by approximately thirty percent. Thus, when the slide-outs 106, 108 are extended, the interior living space of the RV 100 is dramatically increased.

Referring now to FIGS. 3A-3C, there is shown an actuation system comprising a plurality of actuation mechanisms 137 operative to move the slide-outs 106, 108 between an extended and a retracted position. Each actuation mechanism 137 comprises a linear actuator 138. Preferably, the linear actuators 138 are ram actuators. However, it should be understood that the linear actuators 138 may comprise any of a number of alternative actuation mechanisms (e.g., hydraulic, pneumatic, electric, or manual mechanisms, or a combination thereof) without departing from the spirit and scope of the present invention. Each actuation mechanism 137 further comprises a sleeve 140 and a ram arm 142 operatively connected to the linear actuator 138. The sleeve 140 is rigidly connected to a longitudinal support bar 135 of the chassis 102, while the ram arm 142 is rigidly connected to the floor 128 of a respective slide-out 106, 108 and slidably connected to the sleeve 140 so as to be slidable into and out of the respective sleeve 140. In an exemplary embodiment, each slide-out 106, 108 comprises three actuation mechanisms 137 equidistantly spaced along the length of each slide-out 106, 108.

The actuation system further comprises a supplementary support system comprising a plurality of sliders 144. Each slider 144 comprises a telescoping slide operative to allow slidable movement while providing mechanical support. More particularly, each slider 144 comprises a collapsible shaft, one end of the shaft being connected to the roof 120 of the RV 100 and the opposite end thereof being connected to the roof 130 of a respective slide-out 106, 108. In an exemplary embodiment, the actuation system comprises three sliders 144 per slide-out 106, 108.

As described above, the slide-outs 106, 108 are movable from a retracted position to an extended position. To extend the slide-outs 106, 108, the linear actuators 138 of the actuation mechanisms 137 simultaneously extend the ram arms 142 out of the sleeves 140. Conversely, to retract the slide-outs 106, 108, the linear actuators 138 of the actuation mechanisms 137 simultaneously retract the ram arms 142 into respective sleeves 140. As the slide-outs 106, 108 are rigidly attached to the ram arms 142, the slide-outs 106, 108 move with the ram arms 142. The sliders 144 of the supplementary support system allow this sliding movement while providing mechanical support for the upper portion of the respective slide-out 106, 108.

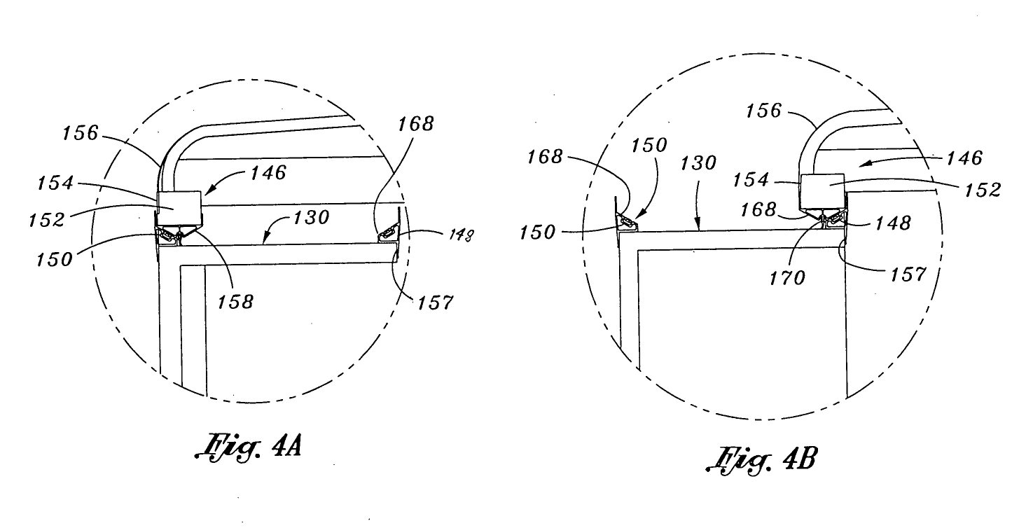

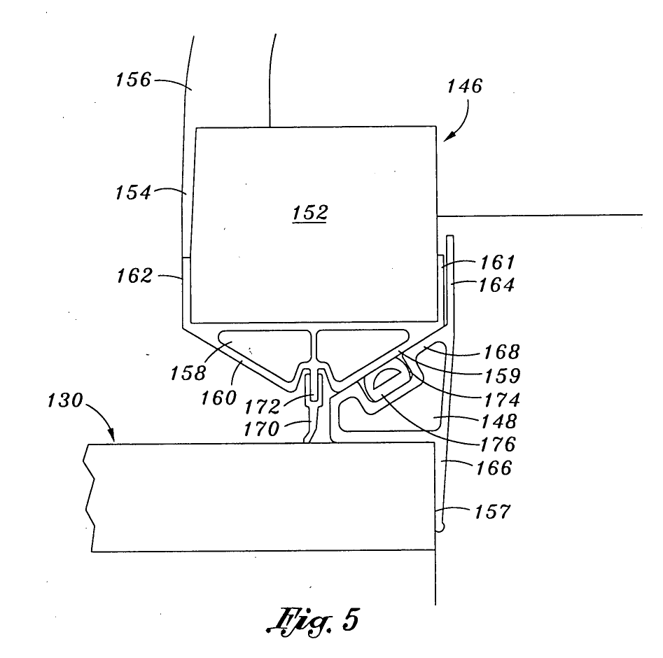

Referring now to FIGS. 4A-4C, the RV 100 further comprises a roof support system for each slide-out 106, 108. The roof support system comprises a roof component 146 of the RV roof 120, an inboard wedge 148, and an outboard wedge 150. The roof component 146 comprises a bar 152 having a solid, rectangular cross-section and rigidly attached (e.g., with fasteners, welds, etc.) to the bottom edge of the RV roof 120 and to a flange 154 which extends from an outer edge 156 of the RV roof 120. The roof component 146 further comprises an abutment member 158 rigidly attached to a bottom surface of the bar 152. The abutment member 158 further comprises an inboard side 159, an outboard side 160, and a seal 170. The abutment member 158 is additionally attached to the bar 152 via an inboard flange 161 and an outboard flange 162 extending along opposing sides of the bar 152 and rigidly attached thereto. Preferably, the bar 152, flange 154, and abutment member 158 span the length of a respective slide-out roof 130.

Each inboard wedge 148 spans the length of a respective slide-out roof 130 and is rigidly connected to the top surface thereof. Each inboard wedge 148 comprises a first flange 164 extending upward so as to be substantially flush with the abutment member inboard flange 161 and a second flange 166 extending downward and rigidly connected to the inboard edge 157 of the slide-out roof 130. Additionally, each inboard wedge 148 comprises an abutment side 168. Preferably, the angle of the abutment side 168 matches that of the inboard side 159 of the abutment member 158. Thus, when a respective slide-out 106, 108 is fully extended, the abutment side 168 of the inboard wedge 148 abuts the inboard side 159 of the abutment member 158. Additionally, the inboard flange 161 of the abutment member 158 abuts the first flange 164 of the inboard wedge 148. Such abutment provides mechanical support for the respective slide-out 106, 108 by distributing the weight thereof over a relatively large surface area (i.e., that of the various abutting surfaces) so as to decrease potentially damaging stress concentrations and reduce the likelihood of the slide-out 106, 108 sagging relative to the RV body.

As shown in FIG. 4C, the structure and function of the outboard wedge 150 of each slide-out 106, 108 are substantially the same as are the structure and function of the inboard wedge 148. In this regard, the outboard wedge 150 is mounted to the outboard end of a respective slide-out roof 130, with the first flange 164 of the outboard wedge 150 extending upward so as to be substantially flush with the abutment member outboard flange 162 and the second flange 166 extending downward and rigidly connected to the outboard side of the slide-out roof 130. Additionally, each outboard wedge 150 comprises an abutment side 168, the angle of which preferably matches that of the outboard side 160 of the abutment member 158. Thus, when a respective slide-out 106, 108 is fully retracted, the abutment side 168 of the outboard wedge 150 abuts the outboard side 160 of the abutment member 158. Additionally, the outboard flange 162 of the abutment member 158 abuts the first flange 164 of the outboard wedge 150. Thus, the abutment of the various components of the outboard wedge 150 and abutment member 158 provides the same mechanical support to the respective slide-out 106, 108 when fully retracted as is provided thereto by the various components of the inboard wedge 148 and abutment member 158 when the slide-out 106, 108 is fully extended.

As also shown in FIGS. 4A-4C, the support system further comprises a seal 170. The seal 170 comprises a thin member made of a flexible material (e.g., rubber) which spans the length of the respective slide-out 106, 108. The seal 170 is attached to the abutment member 134 via a seal flange 172 and extends from the seal flange 172 to the slide-out roof 130, making almost constant contact therewith as the respective slide-out 106, 108 is moved between an extended and a retracted position. Similarly, the inboard and outboard wedges 148, 150 each comprise a channel 174 which spans the length of the respective wedge 148, 150. A seal 176 extends from the channel 174 to the respective abutting side 159, 160 of the abutment member 158. Thus, the seals 170, 176 substantially prevent rain, wind, debris, and the like from entering the interior living space of the RV 100.

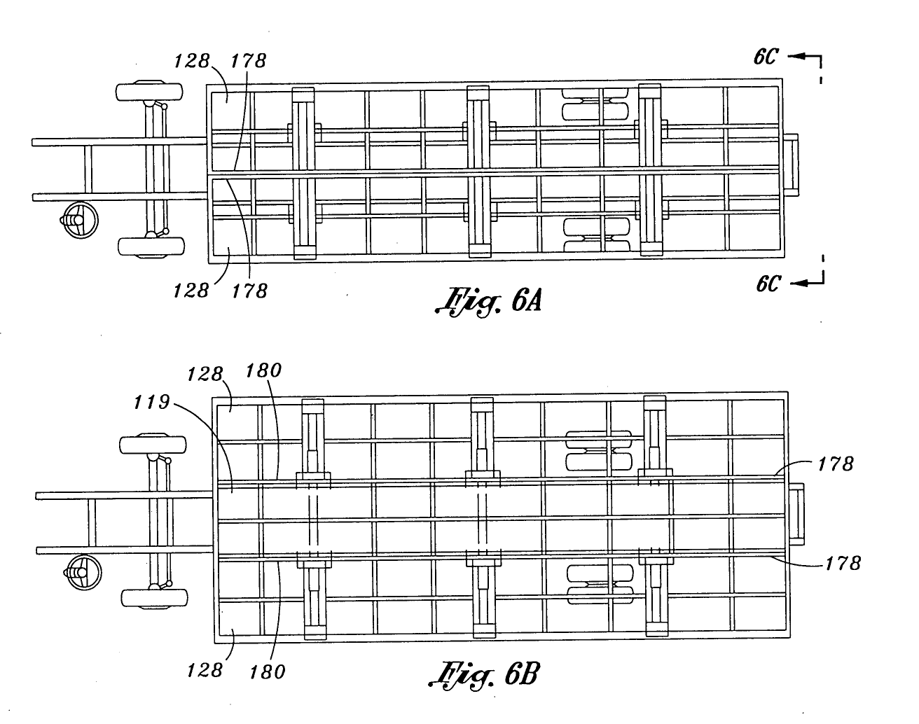

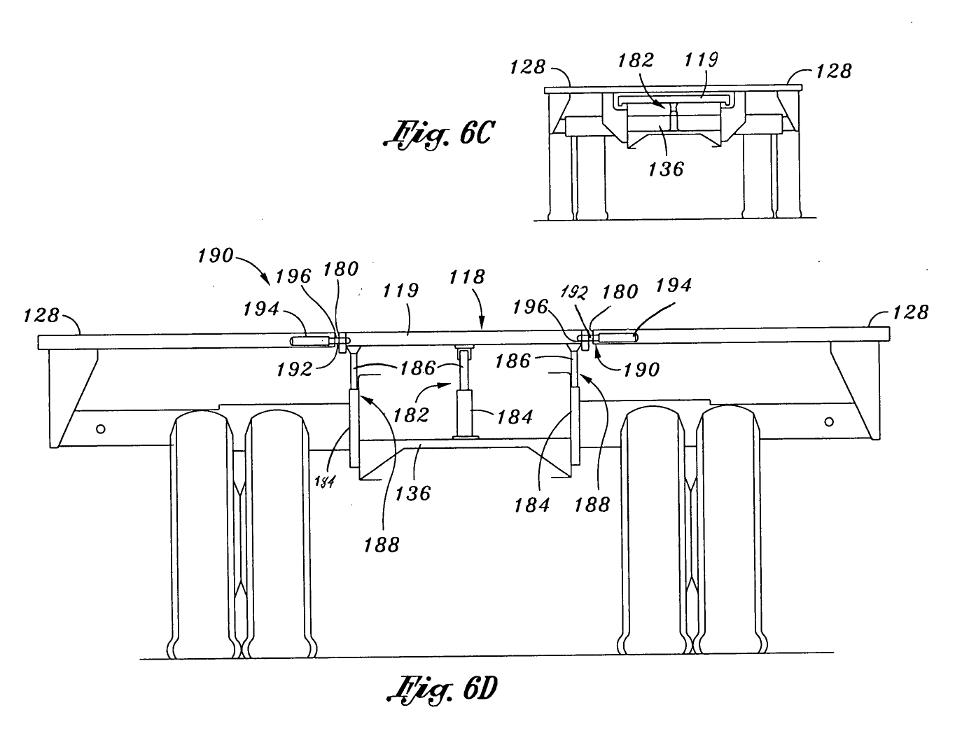

Referring now to FIGS. 6A-6D, the slide-out floors 128 are shown. As seen in FIGS. 6A and 6C, when the slide-outs 106, 108 are in the retracted position, the slide-out floors 128 are positioned within the body of the RV 100 over at least a portion of the interior floor 118 such that the interior edge 178 of one slide-out floor 128 lies flush with the interior edge 178 of the remaining slide-out floor 128. As described above, when the slide-outs 106, 108 are moved to the extended position, the floors 128 thereof are also moved to the extended position, thus leaving a gap between the interior edges 178 of the floors 128 and exposing the retracted interior floor 118.

As shown in FIGS. 6C and 6D, the interior floor 118 comprises a planar floor section 119 having exterior edges 180 with a plurality of openings 196 spaced along the length thereof and a plurality of actuation mechanisms 182 operative to vertically move the planar floor section 119 from an elevated to a retracted position and, conversely, from a retracted to an elevated position. The interior floor 118 additionally comprises a plurality of sliders 188 operative to provide mechanical support thereto. The RV 100 may additionally comprise a non-retractable cab floor (not shown). Each actuation mechanism 182 comprises a sleeve 184 rigidly connected to a lateral support bar 136 of the chassis 102, a ram arm 186 rigidly connected to the planar floor section 119 and slidably connected to the sleeve 184 such that the ram arm 186 is slidable into and out of the sleeve 184, and a linear actuator (not shown). Similarly, each slider 188 comprises a sleeve 184 rigidly connected to the lateral support bar 136 of the chassis 102 and a ram arm 186 rigidly connected to the planar floor section 119 and slidably connected to the sleeve 184 such that the ram arm 186 is slidable into and out of the sleeve 184. Preferably, the linear actuator of the actuation mechanism 182 is a ram actuator. However, it should be understood that the linear actuator may comprise any of a number of alternative actuation mechanisms (e.g., hydraulic, pneumatic, electric, or manual mechanism, or a combination thereof) without departing from the spirit and scope of the present invention.

To elevate the planar floor section 119 of the interior floor 118, the linear actuators of the actuation mechanisms 182 simultaneously extend the ram arms 186 out of the sleeves 184. Conversely, to retract the planar floor section 119, the linear actuators simultaneously retract the ram arms 186 into the sleeves 184. As the planar floor section 119 is rigidly attached to the ram arms 186, the planar floor section 119 moves with the ram arms 186. The sliders 188 mechanically support this vertical movement.

As best seen in FIG. 6C, when the slide-outs 106, 108 are in the retracted position, the planar floor section 119 of the interior floor 118 is retracted such that the slide-out floors 128 are positioned thereabove. As best seen in FIG. 6D, when the slide-outs 106, 108 are moved into the extended position, i.e., when the slide-out floors 128 have been moved to the extended position so as to leave a gap between the interior edges 178 thereof, thus exposing the retracted interior floor 118, the actuation mechanisms 182 vertically move the planar floor section 119 upward such that the exterior edges 180 thereof are flush with respective interior edges 178 of the slide-out floors 128. Thus, when the slide-outs 106, 108 are in the extended position and the planar floor section 119 is in the elevated position, the slide-out floors 128 and planar floor section 119 provide a continuous flush floor space. Advantageously, the retractable interior floor 118 of the present invention precludes the necessity of providing vertical movement to the slide-outs 106, 108. Thus, the size of each slide-out 106, 108 is not limited by the maximum weight a vertical slide-out mechanism can support.

Referring now to FIG. 6D, the RV 100 further includes a floor retention system comprising a plurality of retention mechanisms 190. Preferably, the retention mechanisms 190 are spaced equidistantly along the length of each slide-out floor 128 such that each retention mechanism aligns with a respective opening 196 on an exterior edge 180 of the planar floor section 119 when the planar floor section 119 is in the elevated position. Each retention mechanism 190 comprises a hollow, cylindrically configured sleeve 194 rigidly connected to the interior edge 178 of a respective slide-out floor 128 and a solid, cylindrically configured pin 192 slideably connected to the sleeve 194 such that the pin 192 is slidable into and out of the sleeve 194. The retention mechanisms may be actuated by any of a number of ways (e.g., pneumatically, hydraulically, or manually).

When the slide-outs 106, 108 and the planar floor section 119 are in respective retracted positions, the pin 192 of a respective retention mechanism 190 is retained within the sleeve 194 thereof. As shown in FIG. 6D, when the slide-outs 106, 108 are in the extended position and the planar floor section 119 is in the elevated position, the pin 192 of a respective retention mechanism 190 extends from the sleeve 194 thereof and slides into the opening 196 with which the pin 192 is aligned. The pins 192 are sized and configured so as to be frictionally engageable to respective openings 196. Thus, the retention mechanisms 190 are operative to provide mechanical support and, thus, increase the structural rigidity of the RV 100 when the slide-outs 106, 108 are in the extended position. In this regard, the retention mechanisms 190 resist displacement between the slide-out floors 128 and the planar floor surface 119 of the interior floor 118 by supporting some of the weight of the slide-out 106, 108 that would otherwise be borne by the slide-out actuation system and upper support system described above, thereby decreasing potentially damaging stress concentrations and further reducing the likelihood of the slide-out 106, 108 sagging relative to the RV 100.

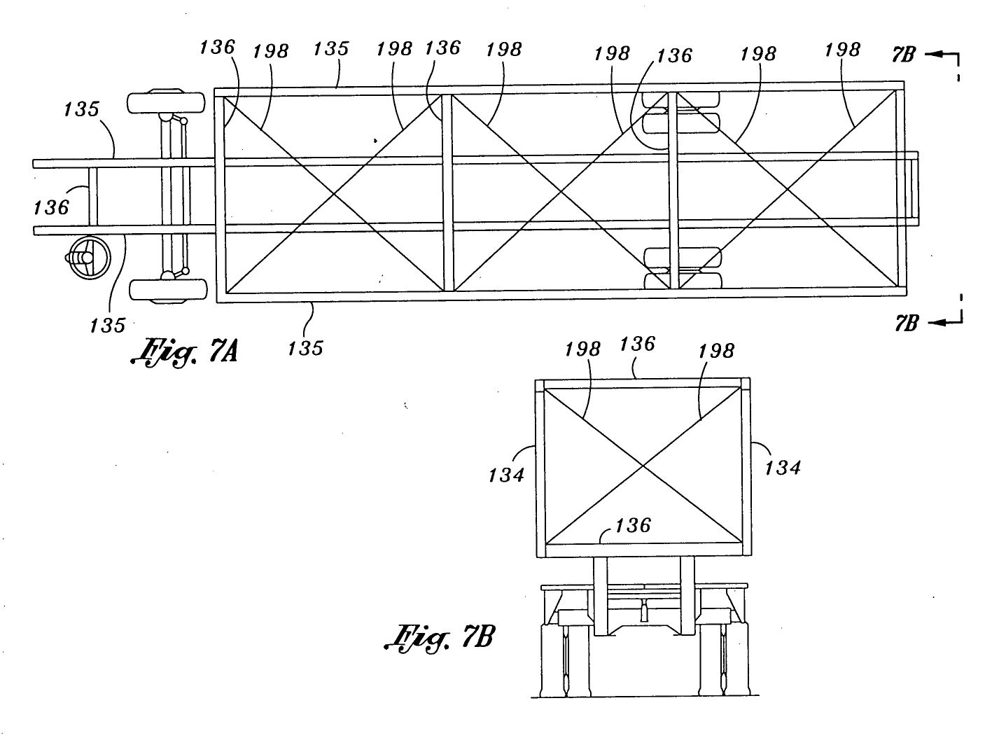

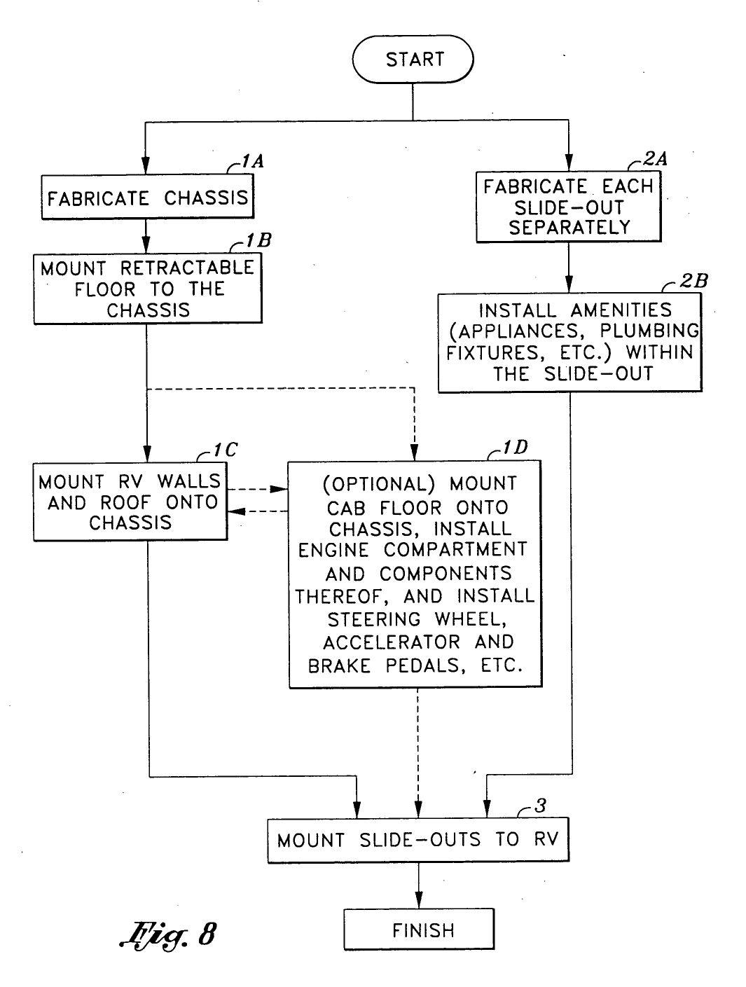

Referring now to FIGS. 7A-7B, the RV 100 may comprise a supplementary structural support system. In an exemplary embodiment, such structural support system comprises a plurality of cables 198 rigidly connected to respective ones of the longitudinal support bars 135 and lateral support bars 136 to provide additional support thereto. As shown in FIG. 7A, each cable 198 extends diagonally across the roof 120 of the RV 100. One end of each cable 198 is rigidly attached to an end of a respective lateral support bar 136 and/or a longitudinal support bar 135 connected to the lateral support bar 136, while the other end is rigidly attached on the opposing side of the roof 120 to an end of a second respective lateral support bar 136 and/or a longitudinal support bar 135 connected to the second lateral support bar 136. Preferably, the cables 198 collectively form a crisscross pattern extending the length of the slide-out roofs 130. Similarly, as shown in FIG. 7B, cables 198 extend diagonally across the back of the RV 100 and forming a crisscross pattern. Such supplementary support system increases the structural integrity of the RV 100.

In an embodiment not shown, the RV 100 may further comprise a visual sensor operative to, when activated (e.g., prior to extending or retracting the slide-outs 106, 108), scan a predetermined area and detect the presence of any objects within that area. In this regard, the visual sensor is configured so as to scan the interior living space of the RV 100 for objects that could interfere with proper movement of the slide-outs 106, 108 and/or retractable interior floor 118. For example, if a person were standing on the planar floor section 119 of the retractable interior floor 118, the visual sensor would detect the presence of that person and send a signal to the floor actuation mechanisms 182 and the slide-out actuation mechanisms 137 to prevent the movement of the retractable interior floor 118 and the slide-outs 106, 108, respectively, thus precluding injury to the person and/or damage to any RV component. Preferably, the visual sensor additionally emits an audible signal to indicate that a person or object has been detected.

Further in accordance with the present invention, there is provided a method of manufacturing an RV 100. As shown in FIG. 8, the method of manufacturing comprises several independent steps. Step 1A comprises fabricating a chassis 102. In this regard, the chassis 102 is fabricated by interconnecting a plurality of beams 134, longitudinal support bars 135, and lateral support bars 136 to form an elongate frame. Preferably, the chassis 102 is fabricated from a strong, durable, lightweight material (e.g., steel). The various components thereof are connected by any of a number of ways (e.g., welding, use of fasteners such as nuts and bolts, or other equivalent means). A front and rear axle each having a plurality of wheels 104 are then mounted to the chassis 102.

Step 1B comprises mounting the retractable interior floor 118 to the chassis 102. In this regard, each actuation mechanism 182 and slider 188 is assembled and then connected via the sleeve 184 to a lateral support bar 136 of the chassis 102 and via the ram arm 186 to the planar floor section 119. The actuation mechanisms 182 and sliders 188 may be connected to the lateral support bar 136 and the planar floor section 119 via welding, use of fasteners such as nuts and bolts, or other equivalent means.

Step 1C comprises mounting the RV walls 110, 112, 114, and 116 to the chassis 102, with the walls 114 and 116 each comprising an opening therein. The roof 120 is then attached to the chassis 102 and to each of the walls 110, 112, 114, and 116. Preferably, the walls and roof are manufactured of a lightweight, durable material (e.g., aluminum or fiberglass) and are fastened with a plurality of fasteners (e.g., nuts and bolts, etc.). A door (not shown) is mounted to at least one of the walls 112, 114, and 116. At least one window is mounted to at least the RV walls 110, 114, and 116. The roof component 146 (i.e., bar 152 and abutment member 158) may be rigidly connected to the roof 120 as described above. Preferably, the roof component 146 is made of a hard material such as a steel alloy. A plurality of cables 198 may be rigidly connected to respective ones of the longitudinal support bars 135, lateral support bars 136, and beams 134 to provide additional support to the chassis 102. Preferably, the cables 198 are manufactured from a strong, relatively lightweight material such as high tensile steel.

Preferably, the RV 100 of the present invention is configured as a motor home. In this case, as shown by Step 1D, a cab floor (not shown) is mounted onto the chassis 102. An engine compartment comprising a motor, transmission, etc. is installed behind the RV wall 110, separate from the cab section. A steering wheel, brake and accelerator pedals, and other components typical of motor vehicles are installed within the cab section. The RV 100 may alternatively be configured as a fifth-wheel or tag-along travel trailer, in which case Step 1D is not included in the manufacturing process.

Steps 2A and 2B are carried out independently of and, preferably, simultaneously with Steps 1A-1D, thus increasing the efficiency of the manufacturing process and decreasing the cost by reducing bottlenecking in the manufacturing process. Step 2A comprises the independent fabrication of each slide-out 106, 108. In this regard, a slide-out frame is preferably assembled from a strong, durable, relatively lightweight material (e.g., steel). A floor 128, front wall 122, back wall 124, and side wall 126 are mounted thereto by means of welding, the use of fasteners such as nuts and bolts, or another equivalent means. A roof 130 is then attached to the frame and to each of the walls 122, 124, and 126. The inboard wedge 148 and outboard wedge 150 of the roof support system are rigidly connected to the roof 130. Preferably, the roof 130 and walls 122, 124, and 126 are made from a durable, lightweight material (e.g., aluminum or fiberglass), while the wedges 148, 150 are made of a hard material such as a steel alloy. Each of the walls 122, 124, and 126 may comprise one or more windows, while the side wall 126 may additionally comprise a door.

Step 2B comprises the installation of any of a number of amenities within a respective slide-out 106, 108. In this regard, one of the slide-outs 106, 108 may be provided with a bathroom comprising a plurality of walls, one of the walls having a door openable into the interior of the RV 100. The bathroom further comprises a bath/shower, a sink, and a toilet, the bath/shower, sink and toilet each in fluid connection with plumbing operative to provide an inflow of water and outflow of waste water. More particularly, a plumbing fixture (e.g., bath/shower, toilet, or sink) may be configured such that holding tanks (i.e., a storage tank for water and for waste water) are mounted adjacent to and/or beneath the plumbing fixture. For example, a sink may be provided having a holding tank for clean water adjacent thereto and a holding tank for waste water mounted beneath the floor 128 of the slide-out 106, 108. One of the slide-outs 106, 108 may additionally be provided with a kitchen having a stove and oven connected to a propane tank, a sink in fluid connection with plumbing operative to provide an inflow of water and outflow of waste water, and a refrigerator which may be connected to a propane tank. Each of these amenities may be mounted adjacent to and/or above a propane tank or a water and waste water holding tank. Likewise, amenities such as furniture, cabinetry, molding, and other features are positioned onto the slide-outs 106, 108. It should be understood that the slide-outs 106, 108 make up the vast majority of the interior space of the RV 100. In this regard, all of the amenities of the RV 100 are mounted to one of the slide-outs 106, 108, while the retractable interior floor 118 and, more particularly, the planar floor section 119 thereof provide additional floor space so as to make the RV 100 more roomy.

Step 3 comprises the slidable mounting of the first and second fully-assembled and finished slide-outs 106, 108 on respective sides of the chassis 102 within the opening of the respective slide-out side wall 126. In this regard, the slide-out 106, 108 is moved beside the RV 100 such that the open side thereof faces the opening of the RV wall. The slide-out 106, 108 is then inserted into the opening. The ram arm 142 of the actuation mechanism 137 is connected to the floor 128 of the slide-out 106, 108 by means of welding, the use of fasteners, or other equivalent means. Likewise, the sleeve 140 thereof is connected to a longitudinal support bar 135 of the chassis 102. Finally, the method of manufacturing comprises the step of slidably mounting the second fully-assembled slide-out 106, 108 on the second side of the chassis (e.g., on the curb side) within the opening of the respective wall (e.g., 116).

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed is:

1. A recreational vehicle comprising:
a chassis;
a cab and a back wall attached to the chassis;
a first side wall at least partially defined by portions of the cab and the back wall; and
at least one slide out moveably attached to the chassis and extending from the cab to the back wall, the slide out defining an outer wall;
the slide out being selectively moveable between a retracted position whereat the outer wall is substantially flush with the first side wall, and an extended position whereat the outer wall projects outwardly from the first side wall.

2. The recreational vehicle of claim 1 wherein:
first and second side walls disposed in opposed relation to each other are at least partially defined by portions of the cab and the back wall;
a pair of slide outs which each define an outer wall are moveably attached to the chassis in opposed relation to each other and extend from the cab to the back wall; and
the slide outs are selectively moveable between a retracted position whereat the outer walls thereof are substantially flush with respective ones of the first and second side walls, and an extended position whereat the outer walls thereof protrude outwardly from respective ones of the first and second side walls.

3. The recreational vehicle of claim 2 further comprising a slide out actuation mechanism attached to the chassis and cooperatively engaged to each of the slide outs, the slide out actuation mechanism being operative to move the slide outs between the extended and retracted positions.

4. The recreational vehicle of claim 3 wherein the slide out actuation mechanism comprises a plurality of linear actuators attached to the chassis in spaced relation to each other.

5. The recreational vehicle of claim 2 wherein:
the recreational vehicle further comprises an interior floor;
each of the slide outs comprises a floor portion;
a portion of the interior floor is exposed between the floor portions when the slide outs are moved to the extended position; and
the interior floor includes a floor section which is moveably mounted to the chasse and selectively moveable between a retracted position and an elevated position between the floor portions of the slide outs;
the floor section being moveable to the elevated position when the slide outs are in the extended position, the floor section and the floor portions of the slide outs collectively defining a generally planar floor surface when the floor section is in the elevated position.

6. The recreational vehicle of claim 5 further comprising a floor actuation mechanism attached to the chassis and cooperatively engaged to the floor section, the floor actuation mechanism being operative to move the floor sections between the retracted and elevated positions.

7. The recreational vehicle of claim 6 wherein the floor actuation mechanism comprises a plurality of linear actuators attached to the chassis in spaced relation to each other.

8. The recreational vehicle of claim 5 further comprising at least one retention mechanism cooperatively engageable to the floor section and to the floor portion of each of the slide outs, the retention mechanism being operative to secure the floor section in the elevated position.

9. The recreational vehicle of claim 5 further comprising a sensor system operative to selectively prevent the movement of the slide outs to the retracted position subsequent to the movement of the floor section to the retracted position.

10. The recreational vehicle of claim 2 wherein each of the slide outs comprises a modular, pre-fabricated unit.

11. The recreational vehicle of claim 2 wherein:
the recreational vehicle further comprises a roof which extends between the chassis and the back wall; and
the first and second sidewalls are at least partially defined by portions of the cab, the back wall, and the roof.

12. In a recreational vehicle comprising a chassis, a cab and a back wall mounted to the chassis, and opposed first and second side walls at least partially defined by portions of the cab, the improvement comprising:
a pair of slide outs moveably attached to the chassis and extending from the cab to the back wall, each of the slide outs defining an outer wall and being selectively moveable between a retracted position whereat the outer walls are substantially flush with respective ones of the first and second side walls, and an extended position whereat the outer walls protrude outwardly from respective ones of the first and second side walls.

13. The recreational vehicle of claim 12 further comprising a slide out actuation mechanism attached to the chassis and cooperatively engaged to each of the slide outs, the slide out actuation mechanism being operative to move the slide outs between the extended and retracted positions.

14. The recreational vehicle of claim 13 wherein the slide out actuation mechanism comprises a plurality of linear actuators attached to the chassis in spaced relation to each other.

15. The recreational vehicle of claim 12 wherein:
the recreational vehicle further comprises an interior floor;
each of the slide outs comprises a floor portion;
a portion of the interior floor is exposed between the floor portions when the slide outs are moved to the extended position; and
the interior floor includes a floor section which is moveably mounted to the chasse and selectively moveable between a retracted position and an elevated position between the floor portions of the slide outs;
the floor section being moveable to the elevated position when the slide outs are in the extended position, the floor section and the floor portions of the slide outs collectively defining a generally planar floor surface when the floor section is in the elevated position.

16. The recreational vehicle of claim 15 further comprising a floor actuation mechanism attached to the chassis and cooperatively engaged to the floor section, the floor actuation mechanism being operative to move the floor sections between the retracted and elevated positions.

17. The recreational vehicle of claim 16 wherein the floor actuation mechanism comprises a plurality of linear actuators attached to the chassis in spaced relation to each other.

18. The recreational vehicle of claim 15 further comprising at least one retention mechanism cooperatively engageable to the floor section and to the floor portion of each of the slide outs, the retention mechanism being operative to secure the floor section in the elevated position.

19. The recreational vehicle of claim 15 further comprising a sensor system operative to selectively prevent the movement of the slide outs to the retracted position subsequent to the movement of the floor section to the retracted position.

20. The recreational vehicle of claim 12 wherein each of the slide outs comprises a modular, pre-fabricated unit.
